(19) United States
(12) Patent Application Publication
(10) Pub. No.: US 2014/0308071 A1
(43) Pub. Date: Oct. 16, 2014

(54) BICYCLE SADDLE CLAMP QUICK-RELEASE

(71) Applicant: PACIFIC CYCLE, LLC, MADISON, WI (US)

(72) Inventors: Jesse C. Darley, Madison, WI (US); Justen D. England, Madison, WI (US); David J. Gennrich, Fitchburg, WI (US)

(73) Assignee: PACIFIC CYCLE, LLC, MADISON, WI (US)

(21) Appl. No.: 14/250,129

(22) Filed: Apr. 10, 2014

Related U.S. Application Data
(60) Provisional application No. 61/810,531, filed on Apr. 10, 2013.

(51) Int. Cl. B62K 19/36

(52) U.S. Cl. CPC B62K 19/36
USPC 403/322.4

(57) ABSTRACT

A quick release bicycle saddle mounting bracket has a mounting portion for a bicycle saddle and a seat post mounting portion including a quick release cam lock. The quick release bicycle saddle mounting bracket may be installed or removed from a bicycle seat post without the use of tools.

### CROSS REFERENCE TO RELATED APPLICATION

This application is based on and claims priority to U.S. Provisional Patent Application No. 61/810,531 filed on Apr. 10, 2013, which is incorporated herein by reference in its entirety for all purposes.

### FIELD OF THE INVENTION

The present invention relates generally to the field of bicycle saddles. More particularly, the present invention relates to a bicycle saddle that may be quickly removed and/or adjusted on a seat post without the use of tools.

### BACKGROUND

When a person buys a new bicycle it typically comes with a saddle attached to a seat post. However, bike riders may want to use different saddles depending on the length or type of ride. The market is flooded with aftermarket saddles of all shapes and sizes that are marketed to cyclists who want a more comfortable or otherwise different ride than the saddle that came with their bicycle.

Sometimes a replacement saddle is the best option for improving the cyclist's comfort. Typical bicycle saddles include rails on the underside of the saddle that attach to a mounting bracket positioned at the top of a seat post.

Adjusting or removing typical bicycle saddles can be a difficult process, and as a result, most bicycle riders do not properly adjust their saddles, nor do they consider the possibility of replacing the saddle for different types of rides. First and foremost, the removal or adjustment of a typical bicycle saddle requires the use of tools. Second, the location of the seat hardware is hard to see, let alone access. As a result, it can be difficult to properly tighten the seat in position, which can cause it to loosen and move while in use.

In other situations, a rider may desire to use a favorite seat on multiple bicycles, or alternatively, may desire to use multiple seats on multiple bicycles. For example, a user may have a certain seat for short distance rides, and a different seat for long distance rides.

In yet another situation, it is common for bicycle riders who lock their bicycles in public places to remove their quick-release seat/seatpost to avoid theft. Removing the entire seatpost is bulky and cumbersome to carry, so many riders simply risk the theft of their seat/seatpost, or otherwise tether the seat post to the bicycle frame.

As such, there is a need for a bicycle saddle that is attached to a seat post by a quick release mechanism, where the quick-release mechanism allows the replacement of the saddle without the use of tools. Attaching the saddle to the seat post by a quick release mechanism decouples saddle adjustment from the seat post attachment, which avoids maladjustment of the saddle during installation.

### SUMMARY

The present invention is a bicycle saddle mounting bracket having a saddle mounting portion attached to a bicycle seat and a seat post mounting portion having a generally cylindrical portion for fitting around a seat post.

Clamping tabs protrude from the generally cylindrical portion of the seat mounting portion. The bicycle saddle mounting bracket includes a tool-less attachment mechanism attached to the clamping tabs that clamp the generally cylindrical portion to the seat post when the tool-less attachment mechanism is tightened.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a perspective view of one embodiment of a bicycle saddle quick release in accordance with the invention showing the bicycle saddle quick release attached to a seat post;

FIG. 2 is a detail perspective view of the bicycle saddle quick release of FIG. 1 showing the quick release mechanism in an open position;

FIG. 3 is a perspective view of the bicycle saddle quick release of FIG. 1 showing the bicycle saddle quick release removed from the seat post;

FIG. 4 is a top view of the bicycle saddle quick release of FIG. 1;

FIG. 5 is a perspective view of an additional embodiment of a bicycle saddle quick release in accordance with the invention; and

FIG. 6 is a top view of the bicycle saddle quick release of FIG. 5.

### DETAILED DESCRIPTION

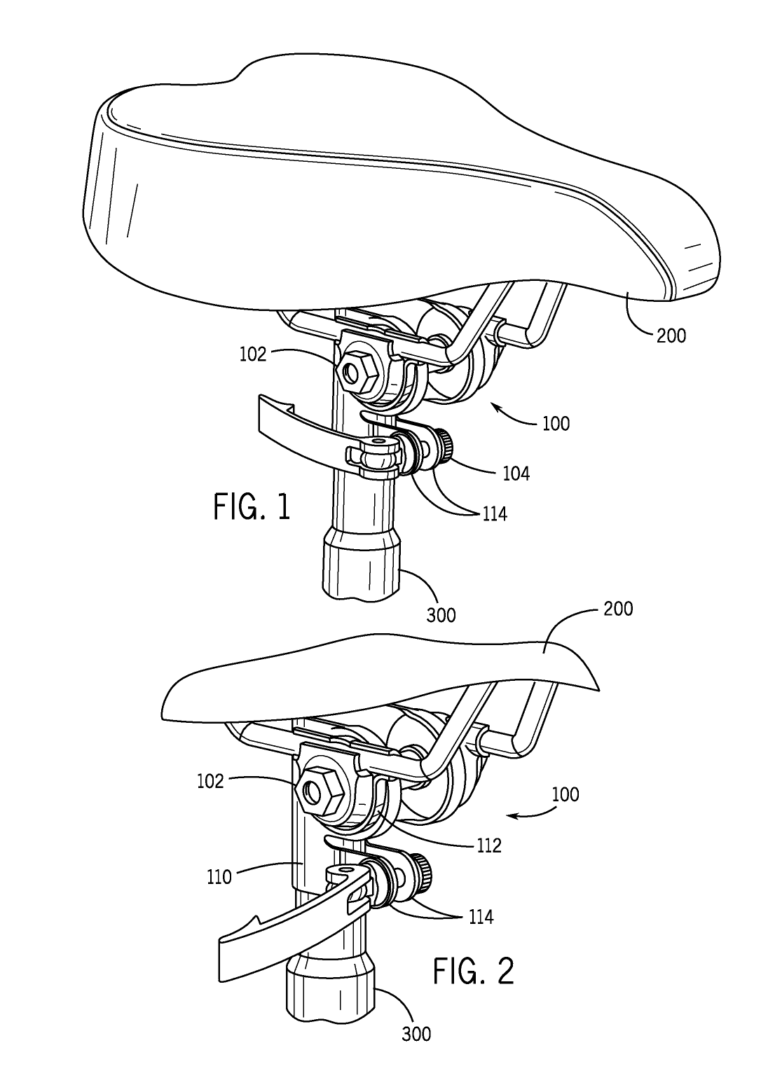

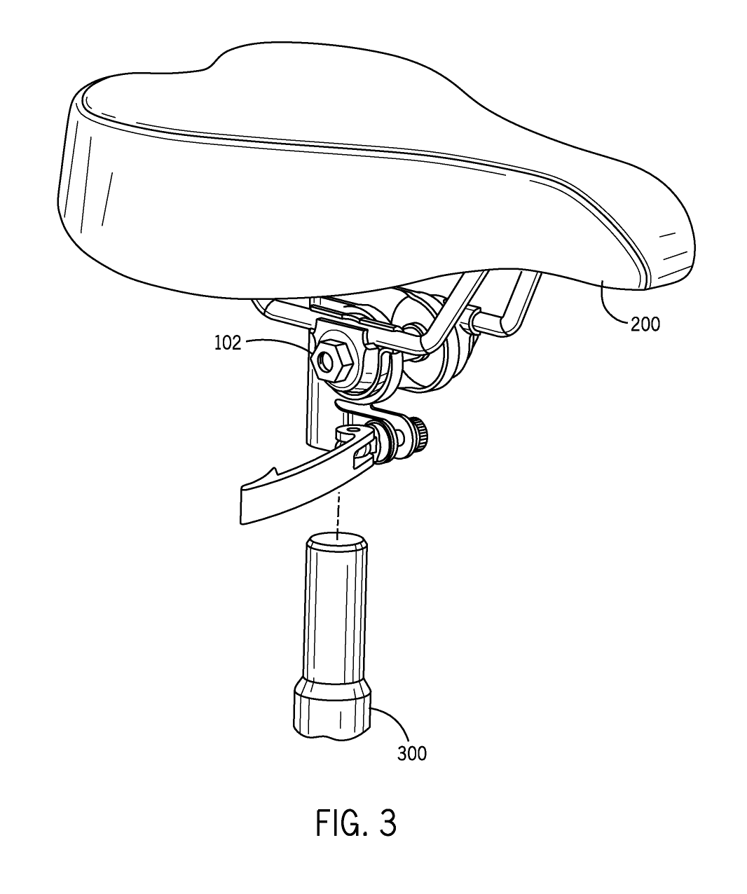

FIGS. 1-4 show one embodiment of a bicycle saddle quick release 100. The bicycle saddle quick release 100 is removably attached to a bicycle saddle 200 and a seat post 300. The bicycle saddle quick release 100 includes a saddle mounting bracket 102 and a quick release cam lock 104. In the embodiment shown, the saddle mount 102 is a conventional “separate clamp” style, but any saddle mount style may be used without departing from the invention. Quick release cam locks 104 are known in the art and are commonly used elsewhere on bicycles, e.g., tire rims and seat post height adjustments, to securely tighten components without the use of tools. Of course, any other suitable tool-less locking mechanism may be used in place of the quick release cam lock 104 without departing from the invention.

As shown, the bicycle saddle quick release 100 includes a seat post mounting portion 110 and a saddle mounting portion 112. The seat post mounting portion 110 is generally cylindrical and passes over the seat post 300. In the embodiment shown, the saddle mounting bracket 102 is made of sheet metal that may be elastically deformed to clamp to the seat post 300 but any other suitable material may be used without departing from the invention. As with all bicycle parts, being lightweight is advantageous, and the embodiment shown achieves maximum lightness by being made of a single piece of sheet metal.

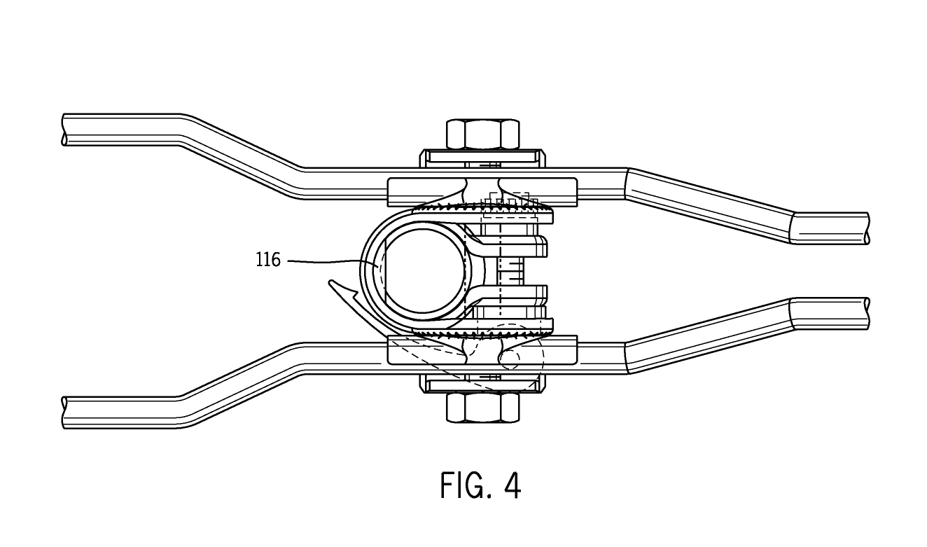

In the embodiment shown, the seat post mounting portion has two clamping portions 114 that extend from the saddle mounting bracket and wrap partially around the seat post 300. The clamping portions 114 include holes through which the quick release cam lock 104 is attached. After placing the saddle mounting bracket 102 onto the seat post 300, the user tightens the quick release cam lock 104, causing the clamping portions 114 to tighten around the seat post, thereby securing the saddle mounting bracket to the seat post. As shown in FIG. 4, a retention tab 116 is included inside the saddle mounting bracket 102. When the saddle mounting bracket 102 is placed on top of the seat post 200, the retention tab 116 prevents the seat post from passing all the way through the saddle mounting bracket and contacting the underside of the saddle 200. As shown the retention tab 116 is integrally formed into the saddle mounting bracket 102, but any suitable constriction into the generally cylindrical shape of the saddle mounting bracket 102 that prevents the seat post 300 from passing through the saddle mounting bracket may be used without departing from the invention.

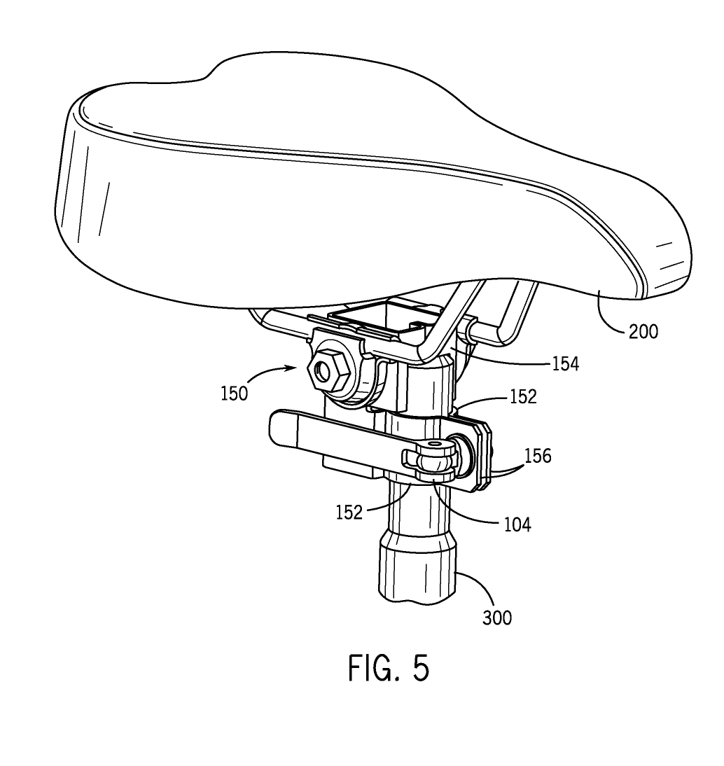

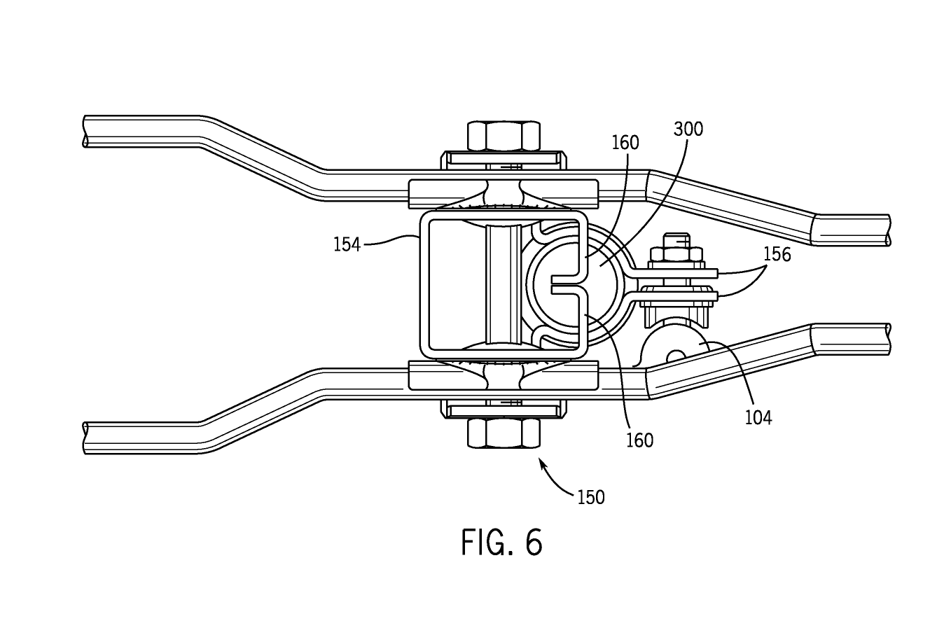

FIGS. 5-6 show an alternative embodiment of a saddle mounting bracket 150 in accordance with the invention. The embodiment shown includes a seat post mounting portion 152 and a saddle mounting portion 154. The seat post mounting portion 152 is generally cylindrical in shape, and the saddle mounting portion 154 has a generally square shape, although other shapes may be used without departing from the invention. The seat post mounting portion 152 includes clamping portions 156 that secure the saddle mounting bracket 150 to the seat post 300. As in the previously described embodiment, a standard quick release cam 104 provides the clamping and locking force to secure the saddle mounting bracket 150 to the seat post 300. In addition to providing a mounting location for the saddle 200, the saddle mounting portion 152 includes upper tabs 160 that prevent the seat post 300 from passing completely through the saddle mounting bracket 150 and contacting the bottom of the saddle 200 or the user. Of course, the upper tabs 160 may have alternative shapes and sizes without departing from the invention.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A bicycle saddle mounting bracket comprising:
a saddle mounting portion attached to a bicycle seat;
a seat post mounting portion having a generally cylindrical portion for fitting around a seat post;
clamping tabs protruding from the generally cylindrical portion; and
a tool-less attachment mechanism attached to the clamping tabs that clamp the generally cylindrical portion to the seat post when the tool-less attachment mechanism is tightened.

2. The bicycle saddle mounting bracket of claim 1, wherein the tool-less attachment mechanism is a cam-lock quick release.

3. The bicycle saddle mounting bracket of claim 1, wherein the seat post mounting portion includes a retention tab that engages the seat post to prevent the seat post from passing through the seat post mounting portion.

4. The bicycle saddle mounting bracket of claim 1, wherein the saddle mounting portion is generally cylindrical.

5. The bicycle saddle mounting bracket of claim 1, wherein the saddle mounting portion is generally rectangular in shape.
